(19) United States
(12) Patent Application Publication
(10) Pub. No.: US 2006/0046027 A1
(43) Pub. Date: Mar. 2, 2006

(54) Discoloration-resistant articles for applying color on surfaces and methods of reducing discoloration in articles for applying color on surfaces

(75) Inventors: Anneke Margaret Kaminski, Cincinnati, OH (US); John Vincent Fontana, Cincinnati, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/203,840

(22) Filed: Aug. 15, 2005

Related U.S. Application Data
(63) Continuation of application No. PCT/US04/04502, filed on Feb. 13, 2004.

(51) Int. Cl. B32B 3/06

(52) U.S. Cl. 428/143

(57) ABSTRACT

Layered articles for applying color on a surface including a sheet of visually-perceivable color effects, a bonding agent capable of bonding the sheet to the surface, and a releasable liner removably attached to the sheet. The article further includes a substance, agent or barrier that prevents or, at the least, reduces the transfer of an extraneous agent from the surface to a location in the layered article that would affect the visually-perceivable color effect conveyed by the sheet.

### FIELD OF THE INVENTION

The invention relates to articles and methods for applying color on a surface and, more particularly, to articles for applying color to a surface that resist discoloration arising from transfer of extraneous agents, such as extraneous dyes and pigments, from the surface to which the article is applied and methods of mitigating or preventing the transfer of extraneous agents responsible for the discoloration.

### BACKGROUND OF THE INVENTION

Thin sheets of visually-perceivable color effects, such as a dry color component, may be adhesively secured to a surface by a bonding layer, typically adhesive, for applying color. Foreign substances or agents in or on the surface, such as pigments in a paint coating, may be solubilized (i.e., dissolve) into the bonding layer and transferred as a permeant to the sheet of visually-perceivable color effects. The presence of certain extraneous agents, originating from the surface and transferred to the sheet, in the sheet of visually-perceivable color effects may result in discoloration of the color effect provided by the article. For example, discoloration may be produced by organic pigments found in common wall paints that are partially solubolized by the bonding layer and subsequently migrate through the bonding layer into the sheet of visually-perceivable color effects. For example, the sheet may be yellowed by the migration of mono-azo based pigments from the surface. Often, the sheet of visually-perceivable color effects includes a topcoat that may inhibit volatilization and release of the extraneous agent from the article and, thereby, hasten accumulation of the extraneous agent in the sheet and the concomitant discoloration. The concentration of the extraneous agent in the sheet of visually-perceivable color effects and, hence, the degree of discoloration increases over the lifetime of the article. Elevated temperature and low molecular weight components in the paint such as ethylene glycol, coalescing aids, and water may accelerate the transfer of the extraneous agent, which would likewise accelerate the discoloration.

### SUMMARY OF THE INVENTION

In accordance with the principles of the invention, an article is provided for conveying visually-perceivable color effects to a surface containing a extraneous agent. The article generally includes a sheet of visually-perceivable color effects, a bonding agent carried by the sheet capable of bonding the sheet to the surface, and a releasable liner removably covering the sheet. In one aspect of the invention, the article may include a barrier layer disposed between the sheet and the bonding agent. The barrier layer is effective for reducing transfer of the extraneous agent from the surface to the sheet. In various specific embodiments, the barrier layer may include a glass-coated polymer, a ceramic-coated polymer, a sodium silicate-containing composition, at least one of an anionic layer and a cationic layer, or a nanocomposite. The barrier layer may optionally incorporate a non-woven material, a metallized material, a cellulosic material, and/or a polymer layer.

Alternatively or in addition to the barrier layer, the sheet, the bonding agent, a tie layer, and/or the barrier layer of the article may include a scavenger material capable of scavenging the extraneous agent to reduce transfer of the extraneous agent from the surface to the sheet. In yet other alternative embodiments, the sheet, the bonding agent, a tie layer, and/or the barrier layer of the article may include a neutralizing agent capable of modifying the extraneous agent to reduce transfer of the extraneous agent from the surface to the sheet. In yet another embodiment of the invention, an article for conveying visually-perceivable color effects to a surface containing a extraneous agent, the bonding agent of the article has a solubility for the extraneous agent that differs substantially from a solubility of the extraneous agent in the surface. In yet another embodiment of the invention, the bonding agent controls discoloration.

In accordance with the invention, a method is provided for preventing and reducing the discoloration of a layered article for conveying visually-perceivable color effects. The method includes adapting the layered article for application to a surface containing an extraneous agent and modifying the layered article to reduce the transfer of the extraneous agent from the surface to a portion of the layered article providing the visually-perceivable color effects by either adding a barrier layer, a scavenger material, and/or a neutralizing agent to one or more layers of the layered article, or by adjusting a solubility of the extraneous agent in one or more layers of the layered article to differ substantially from a solubility of the extraneous agent in the surface.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a diagrammatic view of an article for applying color to a surface in accordance with one embodiment of the invention;

FIG. 1A is a diagrammatic view similar to FIG. 1 in accordance with an embodiment of the invention;

FIG. 2 is a diagrammatic view of an article for applying color to a surface in accordance with an alternative embodiment of the invention;

FIG. 2A is a diagrammatic view similar to FIG. 2 in accordance with an embodiment of the invention;

FIG. 3 is a diagrammatic view of an article for applying color to a surface in accordance with another alternative embodiment of the invention;

FIG. 3A is a diagrammatic view similar to FIG. 3 in accordance with an embodiment of the invention; and

FIG. 4 is a graphical representation illustrating the absorbance of solutions containing a mono-azo pigment with and without the addition of various types of activated carbon.

### DETAILED DESCRIPTION OF THE INVENTION

The invention is directed to articles and methods for applying color on a surface in which the material providing the color is protected against discoloration arising from extraneous agents migrating, diffusing or blooming from the surface to which the article is applied into the portion of the article supplying the color. As employed herein, the term “color” is used to refer to a color effect, i.e., a difference in color perception. In a specific embodiment, the color effect is a substantially permanent color effect, i.e., a color effect which is not removed or noticeably reduced upon casual contact, light washing, or the like. Thus, a substantially permanent color effect is distinguished from a temporary color effect which can be easily removed or reduced, such as that provided by chalk or crayons. The term “color component” is used herein to refer to the component of the inventive articles that provides the color effect. A topcoat or overcoat may also be applied over the color layer. It is to be understood that, in use, the article may provide other functional effects to the surface as well. The primary function of the article is not limited to providing color or other aesthetic effects.

The term “surface” is used herein to refer to any outer layer or boundary of an object or substrate which is capable of receiving a color component thereon. Suitable surfaces may be substantially two-dimensional and flat or substantially three-dimensional and including curves, angled portions or the like. In one embodiment, the surface to which color component is applied using the articles and methods of the invention comprises an architectural surface, i.e., a surface of a building, a building fixture (i.e., appliances), furniture, and the like. The architectural building surface may be an interior surface within the building or an exterior surface on an outer portion of the building. Substantially three-dimensional architectural surfaces can include, for example, edge treatments of two-dimensional surfaces such as moldings (e.g., moldings around windows or doorways), floorboards, appliances, furniture, floors, counters, and the like. The architectural surface may be permanently installed or may be temporarily installed or portable. The products of the present invention can further be applied to surfaces of articles to give them the same or different texture and/or appearance of architectural surfaces. For example, the products hereof can be used to apply a color layer to appliances, furniture, and other architectural articles. Additional surfaces suitable for application of color using the articles and methods of the present invention will be apparent to those skilled in the art in view of the present disclosure.

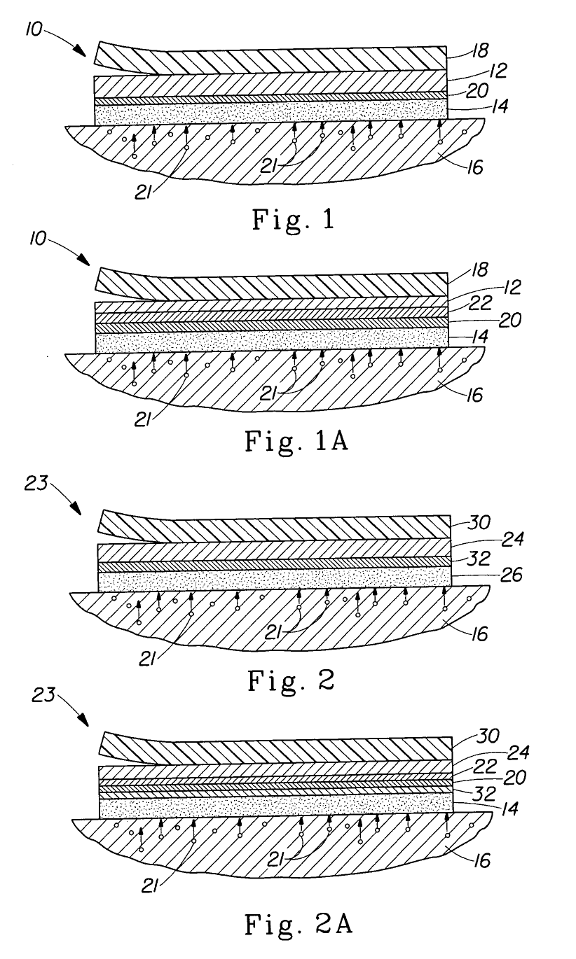

With reference to FIG. 1 and in accordance with the principles of the invention, an article 10 for applying color on a surface 16 comprises a sheet 12 of visually-perceivable color effects, such as a dry color component, a bonding agent 14, such as an adhesive, a releasable liner 18 covering the sheet 12, and a barrier layer 20 situated between the bonding agent 14. The sheet may include a topcoat 15 formed of any suitable material including, but not limited, polymers such as polyurethanes, polyvinyl chlorides, polyvinylidine fluorides, polyacrylates, cellulosic materials and the like, as well as blends and copolymers thereof. The bonding agent is any substance capable of adhering the sheet 12 to the surface 16 at the ambient temperature of environment of the article 10. In certain embodiments of the invention, the sheet 12 may have a thickness of less than or equal to about 0.0033 inch (3.3 mils or 0.084 mm).

The releasable liner 18 is removable and is intended, and adapted, for removal simultaneously with application, or subsequent to application, of the sheet 12 to the surface 16. Typically, the releasable liner 18 is removed by peeling liner 18 from sheet 12. The releasable liner 18 provides structural support and/or strength to the sheet 12, for example when the releasable liner is in film form, and/or to facilitate handling of the article during manufacture, storage and use and may optionally be used to convey a finish to the sheet 12. Exemplary articles 10 are described in commonly-assigned Application Ser. No. 10/324,237 entitled “Articles and Methods for Applying Color on Surfaces,” the disclosure of which is hereby incorporated by reference herein in its entirety.

References herein to terms such as “vertical”, “horizontal”, “under”, “over”, etc. are made by way of example, and not by way of limitation, to establish a frame of reference. It is understood various other frames of reference may be employed without departing from the spirit and scope of the invention.

With continued reference to FIG. 1, the barrier layer 20, may be a prophylactic barrier layer 20 and operates to either eliminate or, at the least, substantially retard the transfer, by mechanisms including but not limited to diffusion and migration, into the sheet 12 of a extraneous (e.g., foreign) substance or agent, diagrammatically shown and labeled with reference numeral 21 in FIG. 1, originating from the surface 16 to be colored. The extraneous agent 21 is understood to be an agent that would be extraneous by its presence with a finite concentration in sheet 12 or would be considered extraneous by increasing an existing concentration of the agent normally present in sheet 12. One such extraneous agent 21 is an organic pigment or dye present in an existing layer, such as an existing paint layer, residing on or covering the surface 16 before the article 10 is applied and with which the bonding agent 14 is mechanically coupled for bonding the article 10 to the surface 16.

The barrier layer 20 may act as a physical barrier that blocks, prohibits or otherwise prevents transfer by defining an impervious or impermeable barrier to the passage or permeation of the extraneous agent 21 so as to prevent or lessen degradation of a property of the article 12, such as preventing the occurrence of discoloration. Alternatively, the barrier layer 20 may slow or retard the transfer rate of the extraneous agent 21 so that a property of sheet 12, such as color, is not perceptibly affected over at least the lifetime of the article 10 for providing surface 16 with color. The thickness and properties of the barrier layer 20 are adjusted to provide the desired blocking or retardation. The barrier layer 20 has a thickness less than or equal to about 0.0025 (2.5 mils or 0.064 mm) and, in certain embodiments of the invention, the barrier layer 20 may be 0.001 inch (0.1 mils or 0.025 mm) or thinner.

The barrier layer 20 is illustrated in FIG. 1 as being incorporated as an identifiable layer, stratum or lamina in the layered structure of article 10. In an alternative embodiment of the invention, a barrier layer 20a, characterized by properties identical to barrier layer 20, may be incorporated as a component of the bonding agent 14. In yet another alternative embodiment, a barrier layer 20b, characterized by properties identical to barrier layer 20, may be incorporated as a component of the sheet 12. The barrier layers 20a and 20b may be segregated as a layer, stratum or lamina positioned within the thickness of the bonding agent 14 or sheet 12, respectively, or may be distributed uniformly throughout the thickness of the corresponding one of the bonding agent 14 or sheet 12. The barrier layers 20, 20a and 20b may be employed individually or incorporated into article 10 in any permutation or combination. Each of the barrier layers 20, 20a and 20b may combine two or more of the candidate materials described herein. The properties of barrier layer 20 described herein are understood to apply equally to barrier layers 20a and 20b.

Generally, the characteristics and properties required for the barrier layer 20 will depend among other things upon the identity of the extraneous agent 21 and its transport mechanism in the barrier layer 20. Several factors are known to influence transport properties of an agent, such as extraneous agent 21, in a material, such as barrier layer 20. The chemical nature of the polymers forming barrier layer 20 influences transport as extraneous agent transfer is believed decrease with increasing strength of the forces holding the polymer chains together. The polymer backbone is recognized to be an important factor in determining the chain-to-chain forces. Polymer chains have to move aside, or open up, to permit agent transfer or permeation. Polymers with hydroxyl, cyano, halogen, ester, and amide linkages are exemplary candidate materials for barrier layer 20, although the invention is not so limited. Generally, any polymer having a glass transition temperature that exceeds the ambient temperature conditions of the environment of the surface 16 to which article 10 is applied will have adequate chain-to-chain force strength.

Another factor influencing the transport of extraneous agent 21 in barrier layer 20 is the susceptibility of the polymer forming the barrier layer 20 to moisture. The barrier properties of polar materials that depend on hydrogen bonding for their barrier properties will diminish in the presence of water. Water swells the polymer, which reduces the chain-to-chain forces and allows permeation. Polymers characterized by such polar linkages include, but are not limited to, esters and cyano.

Yet another factor that affects the transport of extraneous agent 21 in barrier layer 20 is the degree of packing, crystallinity, and orientation of a polymer constituting barrier layer 20. Increasing the crystallinity of barrier layer 20 improves barrier properties as the free volume decreases. Increasing the orientation also improves barrier properties, as the path for agent transfer becomes more tortuous path. However, material stiffness also increases with increasing crystallinity and orientation, which reduces the flexibility of the article 10.

Yet another factor that influences the transport of extraneous agent 21 in barrier layer 20 is the nature of the polymer surface contacting the sheet 12 or bonding agent 14. Hydrophilic or hydrophobic surfaces and/or polar or nonpolar surfaces can prevent or, at the least reduce or retard, the transfer of the extraneous agent 21 from surface 16.

Another factor influencing the transport of extraneous agent 21 in barrier layer 20 is the presence of additives and modifiers. Additives typically act to reduce the chain-to-chain forces making the polymers flexible and, therefore, increasing permeation. Blending a polymer with poor barrier properties with one that has acceptable barrier properties will increase the barrier of the poor barrier material.

In one specific embodiment of the invention, the barrier layer 20 has a composition of about 3 percent by weight to about 40 percent by weight water-glass or sodium silicate (Na₂Si₄O₂), about 3 percent by weight to about 40 percent by weight polymer, and about 20 percent by weight to about 24 percent by weight water. The use of sodium silicate as a barrier layer is described in U.S. Pat. Nos. 1,365,715 and 5,460,855, the disclosures of which are hereby incorporated by reference herein in their entirety. The polymer in the composition lends flexibility to such barrier layers 20 and the presence of water dilutes the composition to facilitate a coating application process. Sodium silicate is manufactures by combining or fusing various ratios of sand and soda ash (i.e., sodium carbonate) at high temperature.

In another specific embodiment of the invention, the barrier layer 20 includes at least one of an anionic layer and a cationic layer capable of capturing or trapping the extraneous agent 21. One technique appropriate for incorporating such anionic and cationic layers into article 10 is by coating sheet 12 with an aqueous dispersion. Suitable cationic and anionic aqueous dispersions are described in U.S. Pat. No. 6,576,327, the disclosure of which is hereby incorporated by reference herein in its entirety. Specific cationic and anionic aqueous dispersions are commercially available, for example, from BASF Aktiengesellschaft (Ludwigshafen, Germany) under the tradenames ACRONAL®, BUTONAL®, STYROFAN®, and PROPIOFAN®. The anionic layers are effective for capturing extraneous agents 21 that are positively charged and cationic layers are effective for capturing extraneous agents 21 that are negatively charged. Frequently, the barrier layer 20 may be constituted by a bilayer or multi-layer structure consisting of spatially-separated anionic and cationic layers so that, regardless of the charge state of the extraneous agent 21, all charged extraneous agent particles are captured and secured against migration into sheet 12. For example, an upstream anionic layer would capture positively-charged extraneous agent particles and transmit negatively-charged foreign particles for capture by a downstream cationic layer more distant from surface 16. Alternatively, the cationic layer of the bilayer or multi-layer structure may be disposed upstream of the anionic layer. Alternatively, either the anionic or cationic layer may be provided in, or mixed as a component of, the bonding agent 14 and the other of the anionic or cationic layer is provided as a separate layer.

In yet another specific embodiment of the invention, the barrier layer 20 is a glass-coated polymer. Suitable glass-coated polymers include, but are not limited to, aluminum oxide-coated polyethyleneterephthalate polymers and copolymers, aluminum oxide-coated polypropylene polymers and copolymers, aluminum oxide-coated nylon polymers and copolymers, and combinations of these materials. Such glass coatings are typically transparent inorganic materials. Such glass coatings may be applied, for example, by a plasma-based deposition process.

In yet another specific embodiment of the invention, the barrier layer 20 is a ceramic-coated polymer. One suitable coating material is silicon oxide (SiOₓ), which may be stoichiometric or non-stoichiometric, that may be deposited by a chemical vapor deposition process using silane as a precursor source. Suitable ceramic-coated materials include, but are not limited to, silicon oxide-coated oriented polypropylene, silicon oxide-coated polyethyleneterephthalate, silicon oxide-coated oriented polyvinyl alcohol, silicon oxide-coated polypropylene, silicon oxide-coated polyethylene, and combinations thereof.

In yet another specific embodiment of the invention, the barrier layer 20 is a nanoclay-based composite material or plastic nanocomposite that creates a tortuous path that the extraneous agent 21 must successfully traverse to reach the sheet 12. The nanoclay-based composite material is formed by dispersing nanoclay platelet particles, tactoids of individual platelet particles, aggregates of tactoids, or mixtures thereof in a polymer host matrix. The nanoclay platelet particles are arranged a sheet-like structure having the form of a plurality of adjacent, bound layers, in which the planar dimensions are significantly larger than the structure's thickness. In certain embodiments of the invention, the nanoclay loading in the host polymer resin may be greater than about 0.5 percent by weight. In other embodiments of the invention, the nanoclay loading in the host polymer resin may range from about 0.5 percent by weight to about 25 percent by weight. In any event, the nanoclay loading is sufficient to define a tortuous path through the host polymer resins. The individual platelet particles may have a thickness of less than about 2 nm and a diameter in the range of from about 10 nm to about 5000 nm.

The nanoclay platelet particles may be composed of any suitable organic or inorganic material and, in particular, may be composed of a phyllosilicate. Natural phyllosilicates suitable for use in the invention include, but are not limited to smectite clays, such as montmorillonite, saponite, hectorite, mica, vermiculite, bentonite, nontronite, beidellite, volkonskoite, magadite, and kenyaite. Synthetic phyllosilicates suitable for use in the invention include, but are not limited to, synthetic mica, synthetic saponite, and synthetic hectorite. Either synthetic or natural phyllosilicates may be modified by fluorination or by the addition of an organic cation. Phyllosilicates suitable for use in the invention are commercially available from various sources, including Nanocor, Inc. (Arlington Heights, Ill.). Host polymer resins suitable for the matrix include, but are not limited to, polyamide polymers and copolymers, polyethyleneterephthalate polymers and copolymers, polypropylene polymers and copolymers, and combinations thereof. The nanoclay platelet particles may be derived from natural, synthetic, and modified phyllosilicates, which may be treated to allow incorporation of organic cations.

Another nanoclay-based polymer material suitable for use in the invention is the AEGIS Nanocomposite Barrier Resin, commercially available from Honeywell, which is based upon nylon 6.

Other inorganic platelet particles suitable for use in the nanocomposite include aluminum or zinc platelets that have a thickness of about 3 μm to 10 μm and a diameter of about 4 μm to 17 μm. These inorganic platelet particles may be provided in any polymer host matrix described above in an amount of between about 0.1 percent by weight and 3.5 percent by weight. Exemplary aluminum platelets are commercially available as aluminum pigment dispersions under the METALURE® tradename from Eckhart America L.P. (Louisville, Ky.).

In yet another specific embodiment of the invention, the barrier layer 20 or sheet 12 is a formed by a polymer having a crystallinity defining the torturous path. The polymer forming barrier layer 20 should have a glass transition temperature that is greater than the temperature of the article 10 while applied to the surface 16 so that the constituent polymer has a low free volume available for migration of the extraneous agent 21.

In yet another specific embodiment of the invention, the bonding agent 14 or sheet 12 may have a solubility for the extraneous agent 21 differs substantially from a solubility of the extraneous agent 21 in the surface 16.l As a result, the extraneous agent 21 is not 20 readily transferred from the surface 16 to the bonding agent 14. If the extraneous agent is prevented from entering the bonding agent 14, then subsequent transfer cannot occur subsequently from the bonding agent 14 to the sheet 12. In this instance, the bonding agent 14 is operating as the barrier layer 20. The solubility of the extraneous agent 21 in bonding agent 14 may be altered by varying the chemistry of the adhesive to modify the bond strength between constituent molecules of the bonding agent 14.

To improve adhesion between the sheet 12 and the barrier layer 20 and/or between the bonding agent 14 and the barrier layer 20, the appropriate surfaces may be surface treated by either corona treatment, roughening of target surface for increasing surface area, swelling of target surface, intermolecular mixing or mutual diffusion, direct coating of bonding agent, applying heat or pressure during lamination, including a functionalized polymer to provide covalent or intermolecular bonds, increasing a surface area of one or more layers by embossing, brushing or other mechanical methods, or by adding particles or by solvent etching, and combinations thereof. Corona treatment, for example, involves exposing the sheet 12 to a high voltage corona discharge while passing sheet 12 between a pair of spaced electrodes.

The invention contemplates that any of the various types of barrier layers 20 described herein may be used singularly or in compatible combinations. For example, the barrier layer 20 may be constituted by a two-layer structure including a lamina of nanoclay-based composite material and a lamina containing sodium silicate.

In yet another specific embodiment of the invention, the barrier layer 20 may further include a sheet or film of a polymer that cooperates with barrier layer 20 for reducing transfer of the extraneous agent 21 from the surface 16 to the sheet 12. The polymer film may also be provided as a lamina in the layered structure of the article 10 distinct from barrier layer 20 or, alternatively, as a lamina disposed in the sheet 12 or in the bonding agent 14. In various embodiments, the polymer sheet or film is selected from the group consisting of polyvinylidene chloride polymers and copolymers, polyvinyl alcohol polymers and copolymers, ethylene vinyl alcohol polymers and copolymers, polycholorotrifluoroethylene polymers and copolymers, acrylonitrile methacrylate polymers and copolymers, polyacrylonitrile polymers and copolymers, aromatic polyamide polymers and copolymers, amorphous polyamide polymers and copolymers, polyethyleneterephthalate polymers and copolymers, polyvinyl chloride polymers and copolymers, polyvinylidene fluoride polymers, liquid crystalline polymers and copolymers, polystyrene, polyethylene, acrylic, styrene-acrylic copolymers, alkyd, polyurethane, polypropylene polymers and copolymers, oriented polypropylene polymers and copolymers, cellulosic polymers, copolymers and coatings, aliphatic polyesters, polyhydroxy alkonals, polycaprolactones, polylactic acid, and combinations thereof. The polymer film resists penetration by the extraneous agent 21 so as to assist the barrier layer 20 in blocking or limiting transfer of extraneous agent 21 to the sheet 12. The invention contemplates that sheet 12 or bonding agent 14 may include one of the listed polymers as a component so a distinct polymer layer is not required in the layered structure of the article 10.

An exemplary polyvinylidene (PVDC) polymer suitable for use as a polymer film in barrier layer 20 is commercially available under the SARAN tradename from The Dow Chemical Company (Midland, Mich.). Exemplary commercial sources of polyvinyl alcohol (PVA) include Clariant GmbH (Frankfurt, Del.) and E.I. Du Pont De Nemours & Co. (Wilmington, Del.). Exemplary ethylene vinyl alcohol copolymers are commercially available under the EVAL® tradename from Kuraray Co., Ltd. (Kurashiki City, Japan) and under the SOARNOL® tradename from Nippon Gohsei (Osaka, Japan). One suitable polycholorotrifluoroethylene (PCTFE) is commercially available under the ACLAR® tradename from Honeywell International Inc. (Morris Township, N.J.). A suitable acrylonitrile methacrylate copolymer is available commercially under the BAREX® tradename from BP, p.l.c. (London, England). An exemplary aromatic polyamide is commercially under the MDX6 tradename from Mitsubishi Gas Chemical America Inc. (New York, N.Y.) and also available commercially from sources such as Honeywell International Inc. (Morris Township, N.J.) and BASF Aktiengesellschaft (Ludwigshafen, Germany). Amorphous polyamide suitable for use in the invention is commercially available under the SELAR® PA tradename from E.I. Du Pont De Nemours & Co. (Wilmington, Del.). An exemplary liquid crystalline polymer is commercially available under the VECTRAN® tradename from Ticona (Summit, N.J.).

The polymer(s), copolymer(s) or (co)polymer blend(s) of the polymer film may optionally be crosslinked by joining adjacent chains to one another either during synthesis or by a non-reversible chemical reaction. Crosslinking may be accomplished by additive atoms or molecules that are covalently bonded to the crosslinked chains. Crosslinking may also be achieved by weaker chemical interactions, portions of crystallites, and even physical entanglement. Crosslinking may operate to improve the resistance of the barrier layer 20 to the transfer of the extraneous agent 21 from the surface 16 to which article 23 is bonded to sheet 12. The polymer film may be formed from either a thermoplastic resin that softens when exposed to heat and returns to its original condition when cooled to room temperature or a thermoset resin that sets irreversibly when heated. Thermoset polymer resins are known to be crosslinked, in contrast to thermoplastic resins.

In yet another specific embodiment of the invention, the barrier layer 20 may further incorporate a nonwoven web consisting of a web having an entangled structure of individual synthetic fibers, filaments, threads or staple length polymeric fibers composed of one or more thermoplastic polymers. The nonwoven web may also be provided as a lamina in the layered structure of the article 10 distinct from barrier layer 20 or, alternatively, as a lamina or distributed component of the sheet 12 or of the bonding agent 14. Nonwoven webs may be formed from many processes such as, for example, meltblowing processes, spunbonding processes, and bonded carded web processes. Generally, spunbond nonwoven webs are formed from consolidated structures or sheets of entangled filaments having average diameters typically between about 10 and 20 microns and meltblown nonwoven webs are formed from consolidated structures or sheets of fibers generally smaller than 10 microns in average diameter. The nonwoven web may consist of a multilayer laminate characterized by a combination of spunbond and meltblown layers. Common thermoplastic polymers used to form nonwoven webs include, but are not limited to, polyolefins such as polyethylene, polypropylene, polybutylene, polyamides such as nylon 6, nylon 6/6, nylon 10, and nylon 12, polyesters such as polyethylene terephthalate and polybutylene terephthalate, polycarbonates, polystyrenes, thermoplastic elastomers, fluoropolymers, vinyl polymers, and blends and copolymers thereof.

In yet another specific embodiment of the invention, the barrier layer 20 may further include a cellulosic nonwoven material formed from an entangled collection or mat of cellulosic fibers, such as wood pulp fibers, cotton (cellulose) fibers, rayon (regenerated cellulose) fibers, acetate (cellulose acetate) fibers, and triacetate (cellulose triacetate) fibers. The cellulosic nonwoven material may also be provided as a lamina in the layered structure of the article 10 distinct from barrier layer 20 or, alternatively, as a lamina or distributed component of the sheet 12 or of the bonding agent 14. The nonwoven material may also be characterized by a composite blend of cellulosic fibers and thermoplastic or synthetic fibers or filaments formed by, for example, by hydroentanglement. The nonwoven material may also be constructed from one or more webs of thermoplastic fibers and filaments and one or more webs of cellulosic fibers laminated together.

In yet another specific embodiment of the invention, the barrier layer 20 may further incorporate a metallized film formed from a metallized coating or foil and, optionally, a single ply of a polymer film to which the metallized coating or foil is laminated. The metallized film may also be provided as a lamina in the layered structure of the article 10 distinct from barrier layer 20 or, alternatively, as a lamina disposed in the sheet 12 or of the bonding agent 14. Suitable metallized films include, but are not limited to, metallized polyethyleneterephthalate polymers and copolymers, metallized polypropylene polymers and copolymers, metallized polyamide polymers and copolymers, metal foil, and combinations of these materials in the form of, for example, layers stacked in a laminate. Metallized films may be formed by a process such as vapor phase metallization or chemical vapor deposition of a metal, such as aluminum or other metals such as gold, silver, and copper, onto at least one planar surface of a polymer film. The metallized film may be introduced into the fabrication process forming the article 10 as a lamination.

In yet another specific embodiment of the invention, the barrier layer 20 may further incorporate a flexible cellulosic material. The flexible cellulosic material may also provided as a lamina in the layered structure of the article 10 distinct from barrier layer 20 or, alternatively, as a portion of the sheet 12 or of the bonding agent 14. The cellulosic material is any material having cellulose or a cellulose derivative as a constituent. Suitable cellulosic materials include, but are not limited to, paper, paper coated with a butyrate lacquer, cotton, typical wood pulps, nonwoody cellulosic fibers, cellulose acetate, cellulose triacetate, rayon, thermomechanical wood pulp, chemical wood pulp, debonded chemical wood pulp, milkweed, bacterial cellulose, and combinations thereof. The fibers may also be crosslinked, sulfonated, mercerized, heat treated, mixed with thermoplastic stabilizer fibers, or treated with wet strength agents. Mixtures of various fibers can be used, including coform, and other mixtures of co-deposited thermoplastic fibers and wood fibers. Cellulose acetate is made from wood pulp processed using acetic anhydride to form acetate flake. Cellulose acetate is manufactured in a wide variety of thicknesses, ranging from 0.001 inch to 0.005 inch (0.025 mm to 0.13 mm), and is normally transparent. Cellulose acetate butyrate is an optically-transparent lacquer that may be applied to paper or consolidated wood pulp.

The cellulosic material may be coated with any conventional pigmented layer or coating containing calcium carbonate, titanium dioxide, silica, satin white, barytes, mica, zinc oxide, plastic pigments, or a kaolin clay pigment, which is composed primarily of kaolinite (a hydrated aluminum silicate (Al₂Si₂O₅(OH)₄)). The pigmented coating is applied to sheet 12 as an aqueous suspension or dispersion of pigment material in a binder, including but not limited to starch, proteins, styrene butadiene dispersions or lattices, polyvinyl acetate and lattices, and acrylic lattices. The presence of the pigmented coating may contribute an additional barrier effect to the cellulosic material, reinforce the barrier effect of the cellulosic material, or endow the cellulosic material with the barrier effect effective to prohibit or retard the transfer of the extraneous agent 21 to layer 12. Generally, such pigmented coatings have a thickness in the range of about 20 μm to about 80 μm. The pigmented coating may be modified by a surface treatment containing, for example, a soluble metal salt to increase its barrier properties.

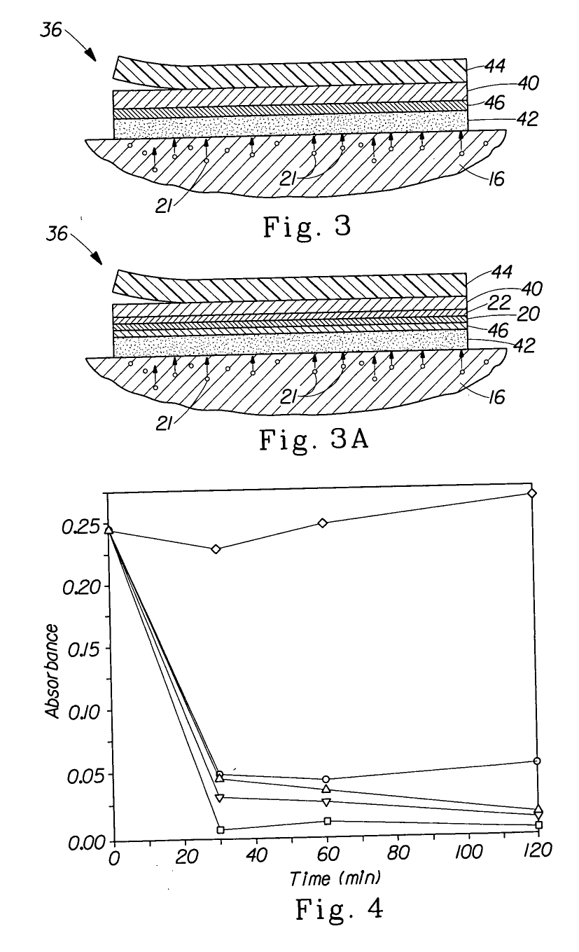

The invention contemplates that the article 10 may, in addition to barrier layer 20, incorporate a scavenger material 32 (FIG. 2) and/or a neutralizing agent 46 (FIG. 3), as described herein that cooperates with barrier layer 20 for reducing or preventing transfer of the extraneous agent 21 from the surface 16 to the sheet 12. The scavenger material 32 and/or neutralizing agent 46 may be provided as a distinct layer or may be included in one or more lamina of the layered article 10, including the sheet 12, the bonding agent 14, and the barrier layer 20. The scavenger material 32 disposed in article 10 may be a material selected from zeolites, mesoporous zeolites, high-surface-area carbon blacks, DGB carbon blacks, polycationic molecules, polyvinylpyrrolidone polymers and copolymers, cyclodextrin compounds, activated carbon, cationic carbons, cationic inert materials, anionic materials, magnesium oxide, activated alumina, mixed metal oxides, nanoparticles of metal oxides, coconut-based carbons, wood-based carbons, carbon nanotubes, carbon nanofibers, ion-exchange resins, dye transfer inhibitors, and combinations, blends or mixtures of these materials.

With reference to FIG. 1A, the article 10 may further comprise one or more tie layers 22 disposed between the sheet 12 and the barrier layer 20, as depicted in FIG. 1A, and/or one or more tie layers (not shown but similar to tie layer(s) 22) disposed between the bonding agent 14 and the barrier layer 20. The invention contemplates that one or more of the tie layers 22 may serve as, or contain, the barrier layer 20. Typical materials forming at least a portion of each tie layer 22 include functionalized polyolefins ethylene acrylate, ethylene vinyl acetate, functionalized acrylics, polyvinyl chloride, polyolefins, polyethoxylate, and combinations, blends and copolymers thereof. Each tie layer 22 may also contain scavenger material 32 (FIG. 2) and/or neutralizing agent 46 (FIG. 3), as described herein, that cooperates with barrier layer 20 for reducing or preventing the transfer of the extraneous agent 21 from the surface 16 to the sheet 12.

With reference to FIG. 2 in which like reference numerals refer to like features in FIG. 1 and in accordance with another embodiment of the invention, an article 23 for applying color on surface 16 comprises a sheet 24 of visually-perceivable color effects, a bonding agent 26, and a releasable liner 30. Sheet 24 is similar to sheet 12 and may include a topcoat 25 as a lamina, bonding agent 26 is similar to bonding agent 14, and releasable liner 30 is identical to releasable liner 18.

In accordance with the principles of the invention, the article 23 further includes a scavenger material, diagrammatically represented by reference numeral 32, capable of either absorbing or capturing a extraneous agent 21 transferred from the surface 16 to which the article 23 is applied such that the extraneous agent 21 cannot affect a property, such as the coloration, of the sheet 24 over the lifetime of the article 23 on the surface 16. The scavenger material 32 scavenges the extraneous agent 21 by either capture, absorption, adsorption or trapping in a manner effective to either block or prevent transfer, such as by diffusion, migration or blooming, of the extraneous agent 21 into the sheet 24, which prevents degradation of a property of the article 23. For example, the action of the scavenger material 32 may eliminate the occurrence of discoloration in the sheet 24. Alternatively, the scavenger material 32 may merely slow or retard the transfer of the extraneous agent 21 by capture or absorption so that a property of sheet 24, such as color, is not perceptibly affected over at least the lifetime of the article 23 while residing on the surface 16. The scavenger material 32 is present with a concentration and/or at a location effective to mitigate, reduce or eliminate the impact of an extraneous agent 21 originating from the surface 16 to the sheet 24. The scavenger material 32 may be applied by various techniques including, but not limited to, as printing, extrusion, co-extrusion, coating, spraying, and combinations of these techniques.

In various specific embodiments of the invention, the scavenger material 32 is a material selected from polycationic molecules, polyvinylpyrrolidone polymers and copolymers, cyclodextrin compounds, activated carbon, cationic carbons, cationic inert materials, anionic materials, magnesium oxide, activated alumina, mixed metal oxides, nanoparticles of metal oxides, coconut-based carbons, wood-based carbons, carbon nanotubes, carbon nanofibers, ion-exchange resins, dye transfer inhibitors, and combinations, blends or mixtures of these materials. The scavenger material 32 may optionally incorporate at least one additional scavenger component selected from zeolites, mesoporous zeolites, high-surface-area carbon blacks, and/or DGB carbon blacks.

The scavenger material 32 is illustrated in FIG. 2 as being confined or incorporated as an identifiable layer, stratum or lamina in the layered structure of article 23. In an alternative embodiment of the invention, a scavenger material 32a, characterized by properties identical to scavenger material 32, may be incorporated as a component of the bonding agent 26. In yet another alternative embodiment, a scavenger material 32b, also characterized by properties identical to a scavenger material 32a, may be incorporated as a component of the sheet 24. The scavenger material 32a and 32b may be segregated as a layer, stratum or lamina positioned within the thickness of the bonding agent 26 or sheet 24, respectively, or may be distributed uniformly throughout the thickness of the corresponding one of the bonding agent 26 or sheet 24. The scavenger materials 32, 32a and 32b may be employed individually or incorporated into article 23 in any permutation or combination. Each of the scavenger materials 32, 32a and 32b may combine two or more of the candidate materials described herein. The properties of scavenger material 32 described herein are understood to be representative of scavenger material 32a and 32b.

In one embodiment of the invention and as mentioned above, the scavenger material 32 in accordance may be a dye transfer inhibitor. The dye transfer inhibitor may be present in either the sheet 24 or the bonding agent 26 in an amount effect to prevent dye transfer to the sheet or retard dye transfer to the sheet 24 over the functional lifetime of the article 23. Generally, the dye transfer inhibitor is present in an amount ranging from about 0.01 percent by weight to about 10 percent by weight of the composition. Suitable dye transfer inhibitors include, but are not limited to, dye polyvinyl pyrolidone polymers, polyamine N-oxide polymers, copolymers of N-vinylpyrrolidone and N-vinylimidazole, manganese phthalocyanine, peroxidases, and combinations thereof. Exemplary dye transfer inhibitors are described in commonly-assigned U.S. Pat. No. 5,633,225, the disclosure of which is hereby incorporated by reference herein in its entirety.

In another embodiment of the invention and as mentioned above, the scavenger material 32 may be activated carbon that, due to its high porosity levels, is capable of absorbing extraneous agents 21 transferred from the surface 16 to which the article 23 is applied. Activated carbon may be provided in either particle forms, fiber forms, nanotube forms, ink forms containing a binder, solvent, ink and activated carbon particles, and mixtures of these various forms. In the particle, fiber, and nanotube forms, the average particle size may be in the range of about 3 μm to about 70 μm and, preferably, is in the range of about 12.5 μm or less. The ink form may be applied as a distinct layer by any conventional printing technique or, alternatively, may be dispersed in the bonding agent 26 and applied by a technique such as printing, extrusion, co-extrusion, coating, spraying, and combinations of these techniques.

Suitable particle forms of activated carbon are commercially available from various sources including Calgon Carbon Corp. (Pittsburgh, Pa.), the Specialty Chemicals Division of MeadWestvaco Corp. (Covington, Va.), and Carbochem Inc. (Ardmore, Pa.). Specific particle forms of activated carbon that may be useful in practicing the invention include Calgon Carbon ADP coconut-based activated carbon, RGC wood-based activated carbon (WAC), RGC WAC +PVAm, Nuchar SN-30 (WAC), and Nuchar SA-1500 (WAC) from MeadWestvaco, and Carbochem CA-10 (WAC).

In another embodiment of the invention and as mentioned above, the scavenger material 32 may comprise a coating applied to sheet 27 containing a cyclodextrin compound, which may be substituted or derivatized. Generally, cyclodextrin is a cyclic oligosaccharide consisting of at least five, preferably at least six, glucopyranose units joined by a-1, 4 linkages. One such cyclodextrin-based barrier layer 20 is an extruded film coating composed of about 0.1 percent by weight to about 60 percent by weight of a cyclodextrin compound dissolved or dispersed in a thermoplastic diluent constituting the balance of the composition. The extruded film coating, which may have a thickness ranging from about 0.3 mil (0.0075 mm) to about 1.5 mil (0.038 mm), is included as a lamination in the structure of the article 23 at a location between the sheet 24 and the bonding agent 26. The cyclodextrin compound may also be applied by solution coating the sheet 24 with an aqueous or other solvent born solution or dispersion of the cyclodextrin compound with an inert carrier or film forming agents (e.g., binder) such as starch, modified starch, cellulose, modified cellulose, and film-forming polymers. After the water or solvent is removed, the residual film should contain about 0.1 grams of cyclodextrin per square meter to about 0.6 grams of cyclodextrin per square meter. Scavenger materials 32 incorporating such cyclodextrin compounds are described in International Application Number PCT/US99/08017.

In another embodiment of the invention and as mentioned above, the scavenger material 32 may comprise an ion-exchange resin. Ion-exchange resins are polymeric resins that contain electrically charged fragments or fixed ions permanently attached to a polymer backbone.

With reference to FIG. 2A in which like reference numerals refer to like features in FIGS. 1A and 2, the article 23 may further comprise one or more tie layers 22 and/or a barrier layer 20 disposed between the sheet 24 and the bonding agent 26. The one or more tie layers 22, the scavenger material 32 and the barrier layer 20, if identifiable as discrete lamina, may be arranged in any suitable order in the thickness of article 23. The tie layer(s) may contain the scavenger material 32 or a portion of the scavenger material 32 that cooperates with another portion of the scavenger material 32 in another lamina of the layer article 23 for reducing or preventing the transfer of the extraneous agent 21 from the surface 16 to the sheet 12. Barrier layer 20 may be any of the candidate barrier layers 20 described herein. Alternatively, barrier layer 20 of article 23 may be formed from a polymer, a cellulosic material, a non-woven material, or a metallized film, as described herein.

With reference to FIG. 3 and in accordance with another embodiment of the invention, an article 36 for applying color on surface 16 comprises a sheet 38 of visually-perceivable color effects, a bonding agent 40, such as adhesive, on one surface 42 of the sheet 38, and a releasable liner 44. Sheet 38 is similar to sheets 12 and 24 and may include a topcoat 45 as a distinct lamina, bonding agent 40 is similar to bonding agents 14 and 26, and releasable liner 44 is identical to releasable liners 18 and 30.

The article 36 further includes a neutralizing agent, diagrammatically represented by reference numeral 46, capable of disrupting the chemical bonds of the extraneous agent 21 transferred from the surface 16. The neutralizing agent 46 disrupts the chemical bonding of the extraneous agent 21 in a manner effective to either block or prevent diffusion into the sheet 38 so as to prevent degradation of a property (e.g., discoloration of a color) of the article 36, such as preventing or lessening the occurrence of discoloration. Alternatively, the neutralizing agent 46 may slow or retard transfer of the extraneous agent 21 so that the property of sheet 38 is not perceptibly affected over at least the functional lifetime of the article 36. The neutralizing agent 46 is present with a concentration and/or at a location effective to reduce or eliminate the transfer extraneous agent 21 from the surface 16 to the sheet 36.

The neutralizing agent 46 is depicted in FIG. 3 as being confined or incorporated as an identifiable layer, stratum or lamina in the layered structure of article 36. In an alternative embodiment of the invention, a neutralizing agent 46a, characterized by properties identical to neutralizing agent 46, may be incorporated as a component of the bonding agent 40. In yet another alternative embodiment, a neutralizing agent 46b, also characterized by properties identical to a neutralizing agent 46a, may be incorporated as a component of the sheet 38. The neutralizing agent 46a and 46b may be segregated as a layer, stratum or lamina positioned within the thickness of the bonding agent 40 or sheet 38, respectively, or may be distributed uniformly throughout the thickness of the corresponding one of the bonding agent 40 or sheet 38. The neutralizing agents 46, 46a and 46b may be employed individually or incorporated into article 36 in any permutation or combination. Each of the neutralizing agents 46, 46a and 46b may combine two or more of the candidate materials described herein. The properties of neutralizing agent 46 described herein are understood to be representative of neutralizing agent 46a and 46b.

In one specific embodiment of the invention, the neutralizing agent 46 is a bleaching compound that neutralizes the color associated with the extraneous agent 21 originating from the surface 16 to which the article 36 is applied. The bleaching compound may any of the oxidizing agents known for laundry, hard surface cleaning, automatic dishwashing or denture cleaning purposes. Bleaching compounds suitable for use in the invention include, but are not limited to, halogen bleaches such as, hypohalites such as hypochlorite bleaches, oxygen bleaches, peroxide bleaches, sodium borohydride, peracids, and mixtures thereof. The bleaching compound operates to disrupt the chemical bonds of the extraneous agent 21 so that it no longer manifests or exhibits a perceptible color that capable of discoloring the sheet 38.

In another specific embodiment, the neutralizing agent 46 is an optical brightener or a fluorescent whitening agent incorporated into the sheet 38 or into the topcoat 45, if present. As know to persons of ordinary skill in the art, optical brighteners are colorless fluorescent dyes commonly used to make white textiles appear visibly brighter. Optical brighteners operate functionally by emitting visible light in a wavelength range of about 400 nm to about 500 nm when exposed to ultraviolet light in a wavelength range of about 300 nm to about 430 nm, such as ultraviolet light contained in artificial or natural light illuminating article 36 when applied to the surface 16. Optical brighteners interfere with dyes or pigments, such as extraneous agent 21, by competing for the activation sites in the sheet 38. The optical brightener operates to visually mask the color manifested by the extraneous agent 21. Optical brighteners are structured molecularly as chromophores constructed from building blocks selected from among vinylene, imino, 2-pyrazoling-1,3-diyl, diyl, 1,4-phenylene, 2,5-furanediyl, 2,5-thiophenediyl, phenyl, fur-2-yl, pyrazol-4-yl, pyrazol-1-yl, 1,2,3-triazol-2-yl, 1,2,4-triazol-1-yl, 1,3,5-triazin-2-yl, 1,2,4-oxadiazol-5-yl, 1,4-naphthylene, benzofuran-2-yl, benzoxazol-2-yl, benzimidazol-2-yl4,7-coumarindiyl, naphtha[1,2-d]triazol-2-yl, naphthalimido, pyren-1-yl, and combinations thereof that are linked together. Suitable optical brighteners are listed in Ullmann's Encyclopedia of Industrial Chemistry, Vol. 18A, pp. 153-176, the disclosure of which is hereby incorporated by reference herein in its entirety.

In yet another specific embodiment of the invention, the neutralizing agent 46 is a pH modifier added to either the sheet 38 or the bonding agent 40 that operates for discoloring the extraneous agent 21 transferred from the surface 16 to which the article 36 is applied. The pH modifier disrupts the chemical bonds of the extraneous agent 21 so that the extraneous agent 21 cannot exhibit or otherwise manifest a visually-perceptible color or, at the least, the ability of the extraneous agent 21 to manifest an intrinsic visually-perceptible color is significantly lessened. The pH modifier may be any acidic or alkaline substance that is chemically compatible with either the material(s) constituting the sheet 38, if added to the sheet 38, and/or that is chemically compatible with the material(s) characterizing the bonding agent 40, if added to the bonding agent 40.

With reference to FIG. 3A in which like reference numerals refer to like features in FIGS. 1A and 3, the article 36 may further comprise one or more tie layers 22 and/or a barrier layer 20 disposed between the sheet 38 and the bonding agent 40. The barrier 20 layer 20 and/or tie layer(s) 22 may also optionally contain scavenger material 32 (FIG. 2), as described herein, that acts in combination with the neutralizing agent 46. The optional scavenger material 32 may also be provided as a distinct lamina in the layered structure of the article 36 or, alternatively, as a portion of the sheet 38 or of the bonding agent 40. Alternatively, scavenger material 32 may be included as a distinct lamina in the layered structure of article 23 and/or may be included as a component or lamina in the sheet 24 and/or the bonding agent 26 of article 23. The barrier layer 20 of article 36 may be any of the barrier layers 20 described herein or, alternatively, may be formed from a material selected from a polymer, a cellulosic material, a non-woven material, or a metallized film. The scavenger material 32 in article 36 may be a material selected from zeolites, mesoporous zeolites, high-surface-area carbon blacks, DGB carbon blacks, polycationic molecules, polyvinylpyrrolidone polymers and copolymers, cyclodextrin compounds, activated carbon, cationic carbons, cationic inert materials, anionic materials, magnesium oxide, activated alumina, mixed metal oxides, nanoparticles of metal oxides, coconut-based carbons, wood-based carbons, carbon nanotubes, carbon nanofibers, ion-exchange resins, dye transfer inhibitors, and combinations, blends or mixtures of these materials.

The invention contemplates that the article 36 may include barrier layer 20 (FIG. 1), scavenger material 32 (FIG. 2) and neutralizing agent 46 (FIG. 3 in any possible permutation or combination. Accordingly, the barrier layer 20, scavenger material 32 and/or neutralizing agent 46 may make individual contributions that collectively operate to reduce or prevent the transfer of extraneous agent 21 from the surface 16 to the sheet 38. In certain embodiments of the invention, the individual contributions may not be sufficient in isolation to achieve the desired prevention or reduction in the transfer of extraneous agent 21 but, collectively, the individual contributions yield the desired effect. The invention also contemplates that more than one type of barrier layer 20, more than one type of scavenger material 32 and/or more than one type of neutralizing agent 46 may be provided, in combination, for supplying a targeted desired prevention or reduction in the transfer of extraneous agent 21.

The barrier layer 20 (FIG. 1), scavenger material 32 (FIG. 2) or neutralizing agent 46 (FIG. 3) may be distributed homogeneously or uniformly over the plane of the corresponding article 10, 23 or 36. Alternatively, the barrier layer 20, scavenger material 32 or neutralizing agent 46 may be distributed in a heterogeneous pattern such that the amount or density of the barrier layer 20, scavenger material 32 or neutralizing agent 46 has a spatial dependence over the article's horizontal plane. For example, the barrier layer 20, scavenger material 32 or neutralizing agent 46 may be absent from certain article areas, may have a concentration or thickness gradient across the article's horizontal plane, may be present in different concentrations or thicknesses in different locations in the article's horizontal plane (i.e., a greater concentration or thickness near the article's peripheral edges), etc. The concentration or thickness in the pattern may be modulated either systematically or randomly, and all areas in the article's horizontal plane may have a non-zero concentration or thickness of the barrier layer 20, scavenger material 32 or neutralizing agent 46.

Color change/stability is measure according to the following procedure. A square sample measuring 7.62 cm per side is provided. The sample is adhesively mounted onto a rigid backing board, being careful to eliminate air bubble and wrinkles. Any overling carrier layer or releasable liner is removed from the sample, exposing the color layer.

The rigid backing board is prepared as follows. A board made of drywall is provided. The board is painted with a commercially available primer, as is available from Behr Corporation as Behr Premium Plus PVA Drywall Primer & Sealer No. 73 white latex. Upon drying the board is painted with a paint having 49.3 grams/liter of pigment. Suitable paint is commercially available from Behr as Behr, Premium Plus Interior Semi-Gloss Enamel Pastel Base no. 3500. Painting may be accomplished with a synthetic lambskin roller having a nap of about 6.35 mm. The board is disposed on a horizontal surface and primed/painted until the surface has a uniform and even coating of primer/paint. A period of 24 hrs occurs between coats at 50 percent RH and 20 degrees C. A baseline L*A*B calorimeter measurement of the sample is made according to ASTM Test Methods E1164 to measure the ample color and E308 to convert the color measurement to L.a.b. scale) A Minolta CM508d colorimeter with a pulsed Xenon arc lamp has been found suitable with the following settings: 2°/C. ; SCE ; 8 mm sample area. After the baseline measurement is taken, the sample is placed in a 60 degree C. test oven. The sample is removed hourly and tested for L*A*B* again as set forth above. The hourly testing occurs until the recorded change in the B*(referred to as ΔB*) is less than 10% between consecutive measurements.

An article 10 according to the present invention may have an opacity of at least 99, preferably at least 99.3 and more preferably at least 99.5 measured according to ASTM standard D2805. Furthermore such article may have a thickness of less than 0.084 mm, preferably less than 0.076 mm, more preferably less than 0.064 mm, more preferably less than 0.05 mm and more preferably less than 0.04 mm measured under a confining load of 8.74 grams with a presser foot diameter of 5 mm. Articles 10 thus made will have an opacity to thickness ratio of at least 40, preferably at least 50 and more preferably at least 55 per mm.

### EXAMPLE 1

Solutions of 10 grams of Hansa Yellow (mono-azo) pigment and 2-propanol (IPA) as prepared. A spectrophotometer was used to find peaks in an absorbance curve of a 10 ppm solution. A principle absorption peak was observed at a wavelength of about 404 nm. All subsequent absorbance readings were made at 404 nm. The absorbance at 404 nm of 2, 4, 6, 8, and 10 ppm solutions were determined for a calibration curve. Various types of activated carbon (approximately 45 to 63 microns in diameter) were added to the 10 ppm solution, which was stirred continuously on a stir plate. A solution lacking carbon was used as a control. Aliquots were removed as samples after 30 min, 60 min, and 120 min. The samples were centrifuged to remove carbon and the absorbance was sampled using the spectrophotometer. The results are presented in FIG. 4.

The uppermost curve represents absorption of the control and the lower four curves represent absorption after addition of various types of activated carbon. It is apparent from FIG. 4 that the absorbance characterizing the 404 nm peak of Hansa Yellow pigment is significantly reduced due to the presence of the activated carbon in the solution. Specifically, the absorbance is reduced by at least a factor of five and as much as over an order of magnitude by the action of activate carbon. In order from least reduction in absorbance to the greatest reduction in absorbance, the specific activated carbons in the solution were MeadWestvaco SA-1500 wood-based activated carbon, wood-based activated carbon, coconut-based activated carbon, and MeadWestvaco RGC wood-based activated carbon, respectively.

Activated carbon, because of its high porosity levels, is effective for absorbing the Hansa Yellow (mono-azo) pigment. Although not shown in FIG. 4, increasing the amount of carbon added to the solution was observed to increase the amount of yellow pigment removed from the solution. It follows that an extraneous agent, if positioned between the sheet of color and the surface to which the article is applied, would be effective in halting the migration of the extraneous agent by operating as a scavenger material. As a result, the sheet of color would not be discolored as the activated carbon would capture migrating extraneous agent before the extraneous agent enters the sheet of color.

Thirty-six additional samples were made and tested according to the procedures set forth above. The results are shown in Table 1 below.

TABLE 1

| | | | | | | | |
|---|---|---|---|---|---|---|---|
| | | | | | | ΔB* | |
| | | | | | | (Reported | |
| | | Coating | | Days to | ΔB @ 384 hrs | Dec. 01, 2003) | |
| | | Concentration | | Visual | Target: | Target: | |
| | | or | Test | Change | ΔB < 0.4 @ | ΔB < 0.4 @ | |
| Material | Material Code | Thickness | Conditions | Target = No Change | 384 hrs | 384 hrs | Comments |

Carbon/
absorbents

| | | | | | | |
|---|---|---|---|---|---|---|
| Carbon Ink | Nuchar PMA Lot #5 | unknown | 60C | 1-13 | | Color change at |
| | (60% carbon) | | | | | thumbprint and other |
| | | | | | | spots. |
| Carbon Ink | Nuchar PMA Lot #5 | 30.0 mg/in² | 60C | no change @ 135 | | carbon coating appears |
| | (60% carbon) | dry carbon | | | | discontinuous/cracked |
| | | (#1) | | | | |
| Carbon Ink | Nuchar PMA Lot #5 | 16.7 mg/in² | 60C | no change @ 135 | | carbon coating appears |
| | (60% carbon) | dry carbon | | | | discontinuous/cracked |
| | | (#2) | | | | |
| Carbon Ink | Nuchar PMA Lot #5 | 15.9 mg/in² | 60C | no change @ 135 | | carbon coating appears |
| | (60% carbon) | dry carbon | | | | discontinuous/cracked |
| | | (#3) | | | | |
| Carbon Ink | Nuchar PMA Lot #5 | 15.4 mg/in² | 60C | 3-4 | | Color change in thin, |
| | (60% carbon) | dry carbon | | | | cracked areas. |
| | | (#4) | | | | |
| Carbon Powder | 5 um RGC | unknown | 60C | 2-6 | | |
| Carbon Powder | 5 um RGC | unknown | 60C | 3-7 | | |
| Talc | Aldrich < 10 um | unknown | 60C | 1 | | |
| PVNO | 2:1 Flexbond AF75: | 20 um of blend | 60C | | 10.7 @ 339 hrs | Laundry DTI polymer |
| | Chromabond | | | | | blended with acrylic |
| | | | | | | adhesive |

Coatings

| | | | | | | |
|---|---|---|---|---|---|---|
| Polystyrene | XU30900.51 | 2.8 mils wet | 60C | 1-13 | | Color change in spots. |
| | | | | | | Crackled texture only |
| | | | | | | where carrier was |
| | | | | | | pulled away but not |
| | | | | | | where rest of carrier |
| | | | | | | was left on. |
| PVDC (film) | Polidene 33-065 | 10 um/15 um | 60C | | 6.5 @ 363 hrs | PVDC copolymer, |
| | (Scott Bader) | AF75 | | | | Tg =+00 19C, latex |
| PVDC (blend) | 3:1 Flexbond AF75: | 20 um of blend | 60C | | 10.0 @ 339 hrs | Latex blended to |
| | Polidene | | | | | produce tortuous path |
| | | | | | | through adhesive |
| PVDC (film) | F278 (Dow) | 10 um/15 um | 60C | | 3.8 @ 365 hrs | PVDC copolymer, |
| | | AF75 | | | | Tg > ambient, solvent |
| | | | | | | cast |
| PVDC (film) | F310 (Dow) | 10 um/15 um | 60C | | 0.57 @ 365 hrs | PVDC:AN copolymer, |
| | | AF75 | | | | Tg > ambient, solvent |
| | | | | | | cast |

Films

| | | | | | | |
|---|---|---|---|---|---|---|
| Purple Pink | Purple Decorate: | 0.5 mil S3506 | 60C | no change @ 240 | | |
| Pak | Made Sep. 06, 2001 | adhesive added | | | | |
| Decorate & | #5A 1%; S3506 | to 0.5 mil Met | | | | |
| 0.5 mil | made Apr. 05, 2003 | PET (plus | | | | |
| XC003 S3506 | | unknown thick- | | | | |
| | | ness adhesive, | | | | |
| | | white coat, | | | | |
| | | color, and | | | | |
| | | varnish | | | | |
| OPP | CPPD film rack | 0.8 mil | 60C | 2-5 | | |
| HDPE | CPPD film rack | 0.5 mil | 60C | 1 | | |
| Mylar ® | CPPD film rack | 0.5 mil | 60C | no change @ 130 | | |
| Mylar | Dupont Teijin Films | 48 gauge | 60C | | 0.39 @ 340 hrs, | ΔB* = 0.76 @ |
| | (type 854) | | | | 0.28 @ 436 hrs | 3516 hours |
| Mylar | Dupont Teijin Films | 48 gauge | 49C | no change | 0.22 @ 360 hrs, | ΔB* = 0.38 @ |
| | (type 854) | | | | 0.19 @ 408 hrs | 3264 hours |
| Mylar | Dupont Teijin Films | 48 gauge | 38C | no change | 0.11 @ 360 hrs, | ΔB* = 0.32 @ |
| | (type 854) | | | | 0.19 @ 408 hrs | 3264 hours |

Paper

| | | | | | | |
|---|---|---|---|---|---|---|
| Thermal Paper | From SJ-301 | 2 mil | 60C | after 24 hrs | | ended at |
| | | | | brownish | | 886 Hrs; ΔB* = |
| | | | | | | 4.57 |
| Bronco Paper | From Desk Cube | 4 mil | 60C | | 0.26 @ 334 hrs, | ΔB* = 0.7 @ |
| | | | | | 0.43 @ 502 hrs | 1582 hrs |
| Brown Crepe | From Bruce | 5 mil | 60C | | 0.26 @ 334 hrs, | ΔB* = 0.7 @ |
| Paper | | | | | 0.42 @ 502 hrs | 1582 hrs |
| Copier Paper | From Printer | 4 mil | 60C | | 0.31 @ 334 hrs, | ΔB* = 0.8 @ |
| | | | | | 0.53 @ 502 hrs | 1582 hrs |
| Filter Paper | Whatman Qualita- | 7 mil | 60C | | 0.56 @ 334 hrs, | ΔB* = 1.1 @ |
| | tive No. 1 | | | | 0.6 @ 502 hrs | 1582 hrs |

Alternative
adhesives

| | | | | |
|---|---|---|---|---|
| Acrylic latex | Flexbond AF 75 | 15 um | 60C | 11 @ 384 hrs |
| Acrylic latex | Flexbond AF 75 | 15 um | 60C | 10.9 @ 384 hrs |
| Acrylic latex | Flexbond AF 75 | 50 um | 60C | 9.3 @ 54 hrs |
| Acrylic latex | Flexbond AF 75 | 100 um | 60C | 9.8 @ 54 hrs |
| Acrylic latex | Flexbond AF 75 | 200 um | 60C | 9.5 @ 54 hrs |
| PIB | MA 24A | 45 um | 60C | 10.2 @ 389 hrs |
| Acrylic | HY3 | 45 um | 60C | 10.1 @ 389 hrs |
| Acrylic | K294 | 15 um | 60C | 10.0 @ 172 hrs |
| Acrylic | PS 8120 | 15 um | 60C | 9.0 @ 172 hrs |
| Acrylic | PS 8211 | 15 um | 60C | 7.8 @ 172 hrs |

All documents cited in the Detailed Description of the Invention are, are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An article for conveying visually-perceivable color effects to a surface comprising:
a sheet of visually-perceivable color effects;
a bonding agent carried by said sheet and capable of bonding said sheet to the surface;
and
a scavenger material operating for scavenging an extraneous agent effective to reduce transfer of the extraneous agent from the surface to said sheet, wherein said scavenger material is selected from the group consisting of polycationic molecules, polyvinylpyrrolidone polymers and copolymers, cyclodextrin compounds, activated carbon, cationic carbons, cationic inert materials, anionic materials, magnesium oxide, activated alumina, mixed metal oxides, nanoparticles of metal oxides, coconut-based carbons, wood-based carbons, carbon nanotubes, carbon nanofibers, ion-exchange resins, dye transfer inhibitors, and combinations thereof.

2. The article of claim 1 further comprising:
at least one of a barrier layer and a tie layer, said scavenger material being present in at least one of said sheet, said bonding agent, said barrier layer, and said tie layer.

3. The article of claim 2 wherein at least one of said bonding agent, said scavenger material, and said sheet further includes at least one of a zeolite, a mesoporous zeolite, a high-surface-area carbon black, and a DGB carbon black that cooperates with said scavenger material for reducing transfer of the extraneous agent from the surface to said sheet.

4. The article of claim 2 wherein at least one of said sheet and said bonding agent includes said scavenger material.

5. The article of claim 1 wherein said scavenger material is positioned as a layer between said sheet and said bonding agent.

6. The article of claim 5 wherein said scavenger material is activated carbon provided in a form selected from the group consisting of a particle, a fiber, a nanotube, an ink, and combinations thereof.

7. An article for conveying visually-perceivable color effects to a surface, said article comprising:
a sheet of visually-perceivable color effects; and
a neutralizing agent operative for modifying an extraneous agent effective to reduce transfer of the extraneous agent from the surface to said sheet.

8. The article of claim 7 further comprising:
at least one of a barrier layer and a tie layer, said neutralizing agent being present in at least one of said sheet, said bonding agent, said barrier layer, and said tie layer.

9. The article of claim 8 wherein at least one of said sheet and said bonding agent includes said neutralizing agent.

10. The article of claim 7 wherein said neutralizing agent is positioned as a layer between said sheet and said bonding agent.

11. The article of claim 7 wherein said neutralizing agent is selected from the group consisting of a bleaching compound, an optical brightener, a pH modifier, and combinations thereof.

12. The article of claim 7 further comprising:
a scavenger material that cooperates with said neutralizing agent for reducing transfer of the extraneous agent from the surface to said sheet.
a barrier layer that cooperates with said neutralizing agent for reducing transfer of the extraneous agent from the surface to said sheet.

14. The article of claim 13 further comprising:
a scavenger material that cooperates with said neutralizing agent and with said barrier layer for reducing transfer of the extraneous agent from the surface to said sheet.

15. An article for conveying visually-perceivable color effects to a surface, said article comprising:
a sheet of visually-perceivable color effects;
wherein said bonding agent has a solubility for an extraneous agent that differs substantially from a solubility of the extraneous agent present on the surface, the solubility difference effective for reducing the transfer of the extraneous agent from the surface to said sheet.

16. A method for preventing and reducing the discoloration of a layered article usable for conveying visually-perceivable color effects to a surface, said method comprising:
providing a layered article for application to a surface; and
modifying the layered article to reduce the transfer of an extraneous agent from the surface to a portion of the layered article providing the visually-perceivable color effects by at least one of:
adding a neutralizing agent to one or more layers of the layered article,
adding a scavenger material to one or more layers of the layered article, the scavenger material selected from the group consisting of polycationic molecules, polyvinylpyrrolidone polymers and copolymers, cyclodextrin compounds, activated carbon, cationic carbons, cationic inert materials, anionic materials, magnesium oxide, activated alumina, mixed metal oxides, nanoparticles of metal oxides, coconut-based carbons, wood-based carbons, carbon nanotubes, carbon nanofibers, ion-exchange resins, dye transfer inhibitors, and combinations thereof, and
adding a barrier layer disposed between the portion of the layered article providing the visually-perceivable color effects and the surface, the barrier layer selected from the group consisting of glass-coated polymers, ceramic-coated polymers, sodium silicate-containing compositions, at least one of an anionic layer and a cationic layer, nanocomposites, and combinations thereof.

17. An article for applying an aesthetic effect to a surface, said article comprising in face to face relationship a color component and a bonding agent for bonding said article to the surface, said article having an opacity to thickness ratio greater than 45.

18. An article according to claim 17 having an opacity to thickness ratio greater than 50.

19. An article according to claim 18 having an opacity to thickness ratio greater than 55.
